(19) United States
(12) Patent Application Publication
(10) Pub. No.: US 2021/0402664 A1
(43) Pub. Date: Dec. 30, 2021

(54) SILICONE RUBBER ROLLER FOR EMBOSSING, PLASTIC FILM PRODUCTION METHOD, A PRODUCTION DEVICE USING SAME, AND SURFACE PROTECTION FILM

(71) Applicant: Toray Advanced Film Co., Ltd., Tokyo (JP)

(72) Inventors: Yoshikazu Nagae, Takatsuki shi, Osaka (JP); Yuuka Tomita, Takatsuki shi, Osaka (JP); Tadashi Matsumoto, Otsu shi, Shiga (JP)

(21) Appl. No.: 17/279,306

(22) PCT Filed: Sep. 13, 2019
(86) PCT No.: PCT/JP2019/036069

§ 371 Date: Mar. 24, 2021

(30) Foreign Application Priority Data
Oct. 1, 2018 (JP) 2018-186355

(51) Int. Cl. B29C 48/00; B29C 48/08; B29C 48/88; B29C 59/04; B29C 59/00

(52) U.S. Cl. CPC B29C 48/002; B29C 48/0011; B29C 48/08; B29L 2007/008; B29C 59/04; B29C 59/002; B29C 48/9135

(57) ABSTRACT

A silicone embossing rubber roller has no fine depression defects on the surface and, furthermore, is not liable to produce protrusions on an embossed plastic film surface. The silicone rubber roller is such that the silicone rubber layer on the surface contains spherical solid particles, and the spherical solid particles having a particle size of 0.8 μm or smaller and the spherical solid particles having a particle size of 30 μm or larger respectively occupy 1% or less of the volume of all the spherical solid particles.

### TECHNICAL FIELD

This disclosure relates to a silicone rubber roller for embossing, a plastic film production method, production apparatus using it, and a surface protection film.

### BACKGROUND

As a conventional embossing roller for forming a crepe pattern on the surface of a plastics film, International Publication WO 2013/080925, for example, proposes a rubber roller having a surface coated with silicone rubber.

The use of a silicone rubber roller as an embossing roller ensures improved release between the resin melted for embossing and the surface of the embossing roller. This increases the finishing speed because winding of the molten resin on the embossing roller is prevented. In addition, the roughness of the crepe surface can be controlled by adopting solid particles having an appropriate particle diameter for addition in the silicone rubber.

International Publication WO 2013/080925 also proposes a technique to prevent protrusions with a size of 0.05 mm2 or more and a height of 5 μm or more from being formed on the embossed surface of a plastic film. This is achieved by adjusting the content of the solid particles mixed as a filler in the silicone rubber such that the volume of those with a particle diameter of more than 19 μm accounts for 1% or less of the total volume of the solid particles. Since a plastic film produced by that technique has no protrusions as described above, bruising by them can be eliminated when it is used as, for example, a surface protection film to cover the surface of a web product such as optical film.

However, various optical films used in flat panel displays are becoming increasingly thin in recent years, and if surface protection film is to be adhered to such an optical film (hereinafter adherend), a protrusion prevention technique as described above is not sufficient since even minute protrusions can cause bruising.

It could therefore be helpful to provide a silicone rubber roller for embossing having no recesses in the surface and accordingly produce a plastic film with an embossed surface free of protrusions, a plastic film production method and apparatus using the rubber roller, and a surface protection film having no protrusions on the surface and causing no bruises on an adherend.

### SUMMARY

We thus provide:

The silicone rubber roller for embossing is a rubber roller having a surface covered by a rubber layer containing silicone as primary component, wherein the rubber layer contains spherical solid particles, and of the spherical solid particles, those with a particle diameter of 0.8 μtm or less and those with a particle diameter of 30 μm or more separately account for 1% or less by volume relative to the total volume of the spherical solid particles.

It is preferable that the spherical solid particles in the silicone rubber roller for embossing are made of silicone resin.

The plastic film production method includes a step of discharging a molten resin from a die and a step of compressing the discharged molten resin between an embossing roller and a cooling roller or a cooling belt so that the molten resin is cooled and solidified to provide a web-like plastic film, wherein the embossing roller is our silicone rubber roller for embossing.

The plastic film production method can include a step of heating and softening a plastic film and a subsequent step of compressing and cooling the softened plastic film between an embossing roller and a cooling roller or a cooling belt so that it is solidified to provide a plastic film, wherein the embossing roller is our silicone rubber roller for embossing.

The plastic film production apparatus can include a die, an embossing roller, and either a cooling roller or a cooling belt, wherein the die, the embossing roller, and the cooling roller or the cooling belt are arranged so that the molten resin is discharged from the die into a web-like form and compressed between the embossing roller and either the cooling roller or the cooling belt, and the embossing roller is our silicone rubber roller for embossing.

The plastic film production apparatus can include a plastic film heating device, an embossing roller, and either a cooling roller or a cooling belt, wherein the die, the embossing roller, and the cooling roller or the cooling belt are arranged so that the plastic film is heated by the plastic film heating device and compressed between the embossing roller and either the cooling roller or the cooling belt, and the embossing roller is our silicone rubber roller for embossing.

The surface protection film can be a monolayer or multilayer surface protection film, wherein: at least either of the outermost surfaces is a crepe surface having fine irregularities, the recesses in the finely irregular surface have substantially hemispherical shapes, whereas the protrusions are formed of a single material, and the material constituting the protrusions is identical to the material constituting the portions containing the recesses.

The terms used below have the following definitions:

A “rubber containing silicone as primary component” is a synthetic rubber identical to the rubber generally called silicone rubber, which contains, as primary component, a linear polymer in which the backbone chain consists mainly of siloxane bonds while the side chains contain organic substituent groups such as methyl group, phenyl group, and vinyl group.

“Primary component” refers to a component that accounts for 51 mass % or more in all rubber components.

“Spherical solid particles” are particles made of a material that is solid at room temperature such as metal, mineral, ceramic, synthetic resin, glass, or a mixture thereof, and each particle has a subsequently spherical shape.

A “silicone resin” is a silicone resin that is solid at room temperature and shows no rubber-like elasticity such as, for example, cured polyorganosilsesquioxane that contains siloxane bonds crosslinked in a three dimensional network structure.

An “embossing roller” is a roller having a surface with a crepe pattern and intended to transfer the crepe pattern to the surface of a plastic film.

A “cooling roller” is a roller that cools and solidifies molten resin by coming in contact with the molten resin.

A “cooling belt” is a belt that cools and solidifies molten resin by coming in contact with the molten resin.

A “receiving roller” is a roller disposed opposite to the embossing roller and works in combination with the embossing roller to compress a plastic film. This is defined to distinguish it from the “cooling roller” designed to cool and solidify completely molten resin.

A “conveying belt” is a belt disposed opposite to the embossing roller and works in combination with the embossing roller to compress a plastic film. This is defined to distinguish it from the “cooling belt” designed to cool and solidify completely molten resin.

A “plastic film heating device” is a device designed to heat at least either surface of a plastic film being conveyed in the length direction to increase its temperature such as, for example, an infrared heater, hot air supplying apparatus, and induction heating roller.

A “surface protection film” is a plastic film designed to be adhered to, for example, an optical plastic film such as retardation film and brightness improving film, or a sheet-like or web-like adherend such as metal foil, glass plate, and resin plate, to protect the surface of the adherend against damage such as flaws and dirt during the production step, conveyance step and the like.

We provide a silicone rubber roller for embossing having no recesses in the surface and accordingly produces a plastic film with an embossed surface free of protrusions, a plastic film production method and apparatus using the rubber roller. We also provide a surface protection film having no protrusions on the surface and causing no bruises on an adherend.

### BRIEF DESCRIPTION OF THE DRAWINGS

FIG. 1 is a schematic cross section view of the silicone rubber roller for embossing.

FIG. 2 is a schematic side view of a plastic film production apparatus according to an example.

FIG. 3 is a schematic side view of a plastic film production apparatus according to another example.

FIG. 4 is a schematic side view of a plastic film production apparatus according to still another example.

FIG. 5 is a schematic side view of a plastic film production apparatus according to still another example.

### EXPLANATION OF NUMERALS

1. T-die

2. molten resin

3. embossing roller

4. cooling roller

5. peeling roller

6. film

7. cutter

8. edge suction tube

9. near roller

10. film roll

11. silicone rubber layer

12. roller core

13. heat transfer medium flow channel

14. bearing

15. slitting step

22. winding-up step

23. film edge

34. cooling belt

35. pressing roller

36. cooling conveyance roller

40. film roll before embossing

41. plastic film heating device

42. receiving roller

46. film before embossing

52. pressing roller

54. conveying belt

55. belt conveying roller

100. silicone rubber roller for embossing

A. film traveling direction

### DETAILED DESCRIPTION

Some most preferred examples will be described below with reference to the drawings.

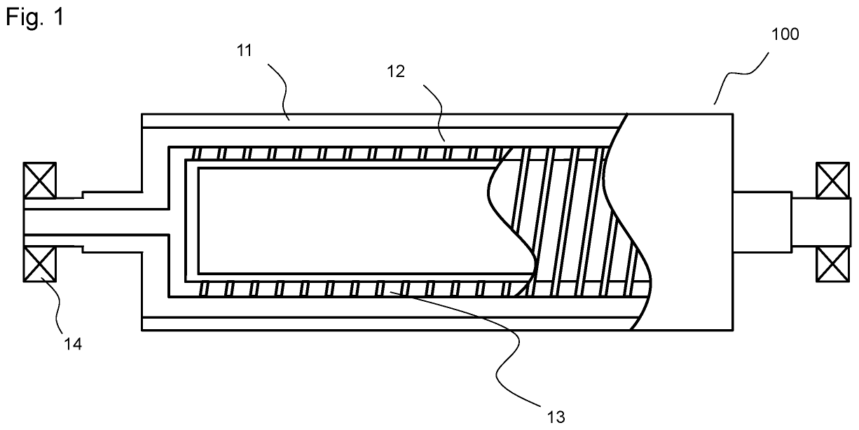

The silicone rubber roller for embossing (occasionally referred to as silicone rubber roller) 100 has a roller core 12 that is covered by a rubber layer 11 that contains silicone as primary component, as illustrated in FIG. 1.

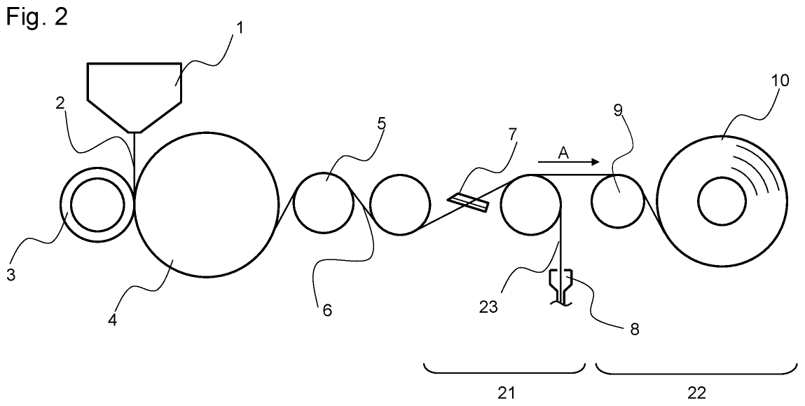

There are no specific limitations on the structure of the roller core 12, but as illustrated in FIG. 1, it preferably has structural features that can control the temperature of the surface of the silicone rubber roller 100, for example, an internal flow channel 13 for circulation of a heat transfer medium such as water. When the silicone rubber roller 100 is used as an embossing roller 3 of a plastic film production apparatus as illustrated in FIGS. 2 to 5, a decrease in its surface temperature realizes easy release of the molten resin to prevent its winding around the embossing roller 3 and increase the solidification rate of the molten resin, thereby enhancing the embossing rate. There are no specific limitations on the material of the roller core 12, and an appropriate one may be selected from common structural materials such as metals, plastics, and fiber reinforced resins, but as in the above example, the use of a metallic material having a low heat conductivity is preferred from the viewpoint of temperature control. Preferred metal materials include, for example, carbon steel, stainless steel, aluminum, and aluminum alloys.

There are no specific limitations on the rubber layer 11 that covers the surface of the roller core 12 as long as it is of a rubber containing silicone as primary component (occasionally referred to as silicone rubber), but it is preferable to use a silicone rubber generally called RTV (room temperature vulcanization) silicone rubber or liquid silicone rubber that is in a liquid state before it is made elastic like rubber by crosslinking. A seamless surface can be produced easily by applying an uncrosslinked liquid rubber on the roller core 12 and then crosslinking it and, therefore, the use of the silicone rubber roller 100 as embossing roller 3 serves to produce a plastic film having an embossed surface free of a transferred seam pattern.

As in producing various rubber rollers, there are many useful methods of covering the surface of the roller core 12 by a rubber layer 11, including a method in which a sheet of uncrosslinked rubber is wound and then crosslinked, a method in which a liquid of uncrosslinked rubber is applied, sprayed on the surface, or injected in a mold and then crosslinked, and a method in which a roller core 12 is inserted in a tube of crosslinked rubber and then adhering them together.

The silicone rubber layer 11 contains spherical solid particles, and of the spherical solid particles, those with a particle diameter of 0.8 μm or less and those with a particle diameter of 30 μm or more separately account for 1% or less by volume relative to the total volume of the spherical solid particles. In addition, it is preferable that, of the spherical solid particles, those with a particle diameter of 8 μm or more account for 1% or less by volume relative to the total volume of the spherical solid particles. Furthermore, it is more preferable that, of the spherical solid particles, those with a particle diameter of 0.8 μm or less and those with a particle diameter of 8 μm or more separately account for 0.1% or less by volume relative to the total volume of the spherical solid particles.

We found that when a surface protection film is adhered to an adherend in the form of, for example, a thin optical film such as cycloolefin resin (COP) film with a thickness of 50 μm or less, bruises can be formed on the surface of the adherend by protrusions with a size of 30 μm or more existing on the embossed surface of the surface protection film. We found that these protrusions are formed as a result of the molten resin flowing into minute depressions with a size of 30 μm or more existing on the surface of the silicone rubber roller for embossing and that most of them result from the shedding of particles contained in the silicone rubber, specifically, agglomerated minute particles with a particle diameter of 0.8 μm or less and bulky particles with a size of 30 μm or more. The size of a protrusion on a film surface and that of a minute depression in the surface of a silicone rubber roller mean the so-called major axis length, that is, the maximum length across a defect measured in the surface direction. also found that particles of irregular shapes such as crushed particles, tend to agglomerate easily due to such shapes regardless of their particle diameters.

We discovered that most of the minute depressions with a particle diameter of 30 μm or more that produce defects in a film embossing process can be eliminated by using a rubber containing spherical solid particles of which those with a particle diameter of 0.8 μm or less and those with a particle diameter of 30 μm or more separately account for 1% or less by volume relative to the total volume of the spherical solid particles. In addition, if the particles with a particle diameter of 8 μm or more account for 1% or less by volume relative to the total volume of the spherical solid particles, it easily produces a surface having a denser and more uniform crepe pattern and easily prevents the crepe pattern formed on the embossed surface from being transferred to the surface of the adherend as it is wound up after adhering a surface protection film. When the surface of rubber layer 11 is polished, furthermore, the resulting chips will be so fine that generation of scratches can be easily prevented in the polishing step. In addition, if the particles with a particle diameter of 0.8 μm or less and those with a particle diameter of 8 μm or more separately account for 0.1% or less by volume relative to the total volume of the spherical solid particles, minute depressions and scratches due to agglomerated particles can be prevented effectively even in a large-type roller having a large surface with a surface length of more than 3 m, for example.

Useful examples of the spherical solid particles include inorganic particles of alumina, silica, glass and the like, and resin powder of fluorine resin, acrylic resin and the like. In addition, these particles may be surface-treated by, for example, silane coupling, and such particles can be used as required. Of these, the use of particles of silicone resin is particularly preferred. We found that if particles of silicone resin are used, a rise in viscosity and deterioration in thixotropy can be reduced compared to other particles when they are mixed in silicone rubber. This reduces bubble generation during their mixing and makes deaeration easy, thereby controlling the depression formation caused by bubbles in the surface of the silicone rubber roller

For the spherical solid particles, a preferred average particle diameter is determined depending on the roughness of the intended crepe surface, but when a plastic film used as surface protection film is to be embossed in a crepe pattern, it is preferable to adopt particles having an average particle diameter of 2 to 5 μm. If it is in this range, the crepe pattern embossed on a film surface can effectively develop good release and slip properties while preventing the transfer of the crepe pattern to the adherend. Measurement of the particle diameter of solid particles can be performed by using a particle size distribution measuring instrument (for example, LMS-30 manufactured by Seishin Enterprise Co., Ltd.) according to the laser diffraction and scattering method.

An appropriate content of the spherical solid particles in the silicone rubber is determined depending on the roughness and rubber hardness of the intended embossed surface having a crepe pattern, but in general, their permissible content by volume is in the rage of about 20% to 70% relative to the total volume of the rubber and particles.

The silicone rubber layer 11 that contains the above spherical solid particles is required only to cover at least the outermost layer of the silicone rubber roller 100 for embossing. For example, another rubber layer or an adhesive layer for adhesion between the rubber layer 11 and the roller core 12 may be provided between the silicone rubber layer 11 containing the spherical particles and the roller core 12. Preferred examples of such another rubber layer include, for example, a layer of high heat-conductivity HTV silicone rubber containing alumina particles and a layer of a rubber that is softer than the rubber of the silicone rubber layer containing the above spherical solid particles. The existence of a heat-conductivity rubber layer serves for easy temperature control of the surface of the silicone rubber roller 100. The existence of a soft rubber layer realizes a wider contact width with the molten resin 2 and the embossed surface of the film 46 and easy cooling of the molten resin 2 and the film 46, leading to a higher embossing rate.

There are no specific limitations on the rubber hardness of the silicone rubber layer 11, but its rubber hardness is preferably 40 to 90 Hs according to JIS A (JIS K 6301-1995). In a structure in which another rubber layer is added as described above, it is preferable for the whole rubber in the stacked layers to meet the above requirement. If the rubber hardness is in the above range, the uneven contact pressure that occurs in association with the processing accuracy of the silicone rubber roller, the opposed roller and the like, and thickness irregularity in the film in the width direction can be relaxed easily in the embossing step to achieve uniform embossing easily.

There are no specific limitations on the thickness of the silicone rubber layer 11, but it is preferable to use a rubber layer of about 1 to 15 mm for coverage. In a structure in which another rubber layer is added as described above, it is preferable for the whole rubber in the stacked layers to meet the above requirement. If the thickness is in the above range, the uneven contact pressure that occurs in association with the processing accuracy of the silicone rubber roller, the opposed roller and the like, and thickness irregularity in the film in the width direction can be relaxed easily in the embossing step to achieve uniform embossing easily. In addition, temperature control can be performed easily when the surface temperature of the silicone rubber roller 100 is controlled by, for example, a structure for internal circulation of a heat transfer medium in the roller core 12.

The silicone rubber roller 100 may have a so-called “crown” type structure in which the outside diameter gradually decreases from the central region toward the edge. If the silicone rubber roller 100 has a proper crown shape depending on the length, rigidity (resistance to deflection), and embossing pressure, it achieves a uniform pressure distribution in the width direction to ensure easy production of a film having a crepe surface uniformly embossed in the width direction. Unlike the silicone rubber layer 11 having a crown type structure, the roller core 11 may have a crown type structure whereas the silicone rubber layer 11 has a constant outside diameter to have the same effect. In this example, the surface having a constant outside diameter is preferred because abrasion due to a variation in the circumferential speed in the axis direction will not occur.

There are no specific limitations on inclusion of a step of removal machining on the surface of the silicone rubber layer 11 or on the method to be used for the removal machining step, but it is preferable that surface polishing with a grindstone is performed for finishing by removal machining. If surface polishing is performed with a grindstone, streak-like polishing flaws and scratches will not be formed easily compared to cutting or polishing with a cutter or sand paper and, in addition, compared to when the surface is not finished by removal machining, it will be easier to reduce the change in surface profile caused by initial abrasion that may occur at the start of use of the silicone rubber roller 100 as embossing roller.

FIG. 2 shows an example of a first example of the plastic film production apparatus. In the first example of the plastic film production apparatus, molten resin 2 is discharged from a T-die 1 and then compressed and cooled between a cooling roller 4 and an embossing roller 3 to produce a plastic film 6. Subsequently, if necessary, the film is cut or trimmed to remove the edges 23 in a slitting step 21 and wound up into a roll in a wind-up step 22 to provide a film roll 10. Then, if necessary, the film may be subjected to another slitting step or other processing steps to provide a product roll. It is noted that the die is not necessarily a T-die, but the use of a T-die is generally preferred.

Molten resin 2, supplied after being melt-kneaded in an extruder, which is not included in the figure, is discharged continuously from the T-die 1 through a slit, which is positioned in the direction perpendicular to the plane of the figure, so that the molten resin 2 is extruded into a sheet. It is preferable to provide a filtrating device that is generally called polymer filter between the extruder and the T-die 1 because it effectively prevents foreign objects called fish eyes and deteriorated resin from getting mixed. It is preferable that the slit width of the T-die 1 is adjustable by increments in the width direction of the film 6 to control the thickness unevenness of the film 6 in the width direction. The thickness of the film 6 being produced can be controlled by changing the ratio between the discharging speed of the molten resin 2 and the rotating speed of the cooling roller 4. To produce a film 6 having a multilayer structure, a molten resin layer stacking device, called feedblock, may be provided on the upstream side of the T-die 1, or a T-die 1 having a structure containing a plurality of manifolds, called multi-manifold structure, is used to perform co-extrusion to produce a multilayer film. Another good method is to adopt a structure in which the width of the flow channel of the molten resin 2 can be controlled in the width direction of the film so that the width of the film 6 to be produced can be changed.

It is preferable to adopt a structure in which the positional relation among the T-die 1, cooling roller 2, and embossing roller 3 is adjustable. Commonly, it is preferable that compression of the molten resin 2 is performed before cooling while it is in a molten state to allow the surface pattern of the embossing roller 3 to be transferred accurately to the molten resin 2. Therefore, as illustrated in FIG. 2, it is preferable that the position of the T-die 1 or the cooling roller 4 is adjusted so that the molten resin 2 comes directly to the nip point, but it is also preferable that the positional relation among the T-die 1, cooling roller 4, and embossing roller 3 is adjusted appropriately in order to control the state of transfer from the cooling roller 4 and embossing roller 3 to each surface of the film 6.

The temperature of the molten resin 2 is appropriately set in consideration of the type of resin used and the embossing rate, but in a common polyethylene resin, for example, an appropriate temperature can be normally selected at of about 130° C. to 300° C.

For example, the cooling roller 4 has a flow channel in its interior so that a heat transfer medium can be circulated to control the surface temperature. The surface temperature of the cooling roller 4 is appropriately set in consideration of the type of the molten resin 2, the contact time between the molten resin 2 and the cooling roller 4, and the environmental temperature and humidity, but a temperature of 10° C. to 60° C. is preferred from the viewpoint of the film production speed and surface quality of the film. If the surface temperature of the cooling roller 4 is in the above range, the cooling and solidification of the molten resin 2 can be performed easily in a practical range of film production rate, and it also enables easy prevention of deterioration in the surface quality of the film 6 that can be caused by moisture condensation on the surface of the cooling roller 4 during film production.

There are no specific limitations on the material to be used for the surface of the cooling roller 4 and useful ones include metal, ceramics, resin, composite film of resin and metal, and film coated with carbon material such as diamond-like carbon. In addition, rubber can also be used as surface material for the cooling roller 4. Preferred metals include iron, steel, stainless steel, aluminum, titanium, chromium, and nickel. Preferred ceramics, on the other hand, include alumina, sintered silicon carbide, and nitride silicon that have been sintered. The surface pattern on the cooling roller 4 is transferred to the molten resin to give the pattern to the surface of the film 6 opposite to that coming in contact with the embossing roller 3 and, therefore, the use of an industrial chromium-plated surface, ceramic surface or the like, that is high in durability and rust resistance is preferred from the viewpoint of preventing deterioration in appearance quality of the film 6 and generation of protruding defects. To produce a cooling roller 4 with a metal surface, there are generally known useful surface treatment techniques including electric plating and electroless plating in addition to the common machining of metal materials. To produce a ceramic surface, furthermore, there are also generally known useful surface treatment techniques including flame-spraying and coating in addition to the common machining of ceramic materials.

The surface pattern on the cooling roller 4 is transferred to the molten resin 2 to give the pattern to the surface of the film 6 opposite to that coming in contact with the embossing roller 3. Therefore, the surface pattern on the cooling roller 4 is designed appropriately according to the features of the film 6 to be produced using our plastic film production apparatus, but when producing a surface protection film, it is preferable for the cooling roller 4 to have an arithmetic average roughness Ra (JIS B0601: 2013) of 0.2 μm or less, and Ra is more preferably 0.1 μm or less. When producing a surface protection film, the aforementioned opposite surface (referred to as tacky surface) adheres to the surface of the adherend, and the above roughness range is preferred because the tackiness decreases with an increasing arithmetic average roughness Ra of the tacky surface, leading to weaker adhesion. Tackiness can be increased by adding an additive such as a tackifier to the resin, but such an additive may remain on the adherend after removing the surface protection film from the adherend, and the additive may make the recycling of the resin difficult. Therefore, it is preferable from the viewpoint of both quality and cost that the surface roughness is maintained in the above range to allow a surface protection film of an additive-free resin material to develop a sufficiently large tackiness. An arithmetic average roughness Ra of 0.001 μm or more is preferred because it is very difficult and costly to produce a roller with an arithmetic average roughness Ra of less than 0.001 although the advantageous effects will not be impaired if it is less than 0.001 μm. A cooling roller 4 with an arithmetic average roughness Ra of less than 0.2 μm can be prepared by a common mirror polishing technique such as, for example, buffing.

The embossing roller 3 is the silicone rubber roller 100 for embossing. As described above, the silicone rubber roller 100 for embossing has only a small number of surface depressions with a size of 30 μm or more. Since protrusion defects are formed as molten resin solidifies after flowing into depressions in the surface of an embossing roller, the use of the silicone rubber roller as the embossing roller 3 can control the formation of protrusion defects on the surface of the film 6 facing the embossing roller 3. It is known, as described above, that if the film 6 produced is used as a surface protection film, bruises are likely to be caused on the adherend by protrusion defects with a size of 30 μm or more, but we largely decrease the number of such bruises.

Useful techniques to press the embossing roller 3 against the cooling roller 4 to compress the molten resin 2 include one designed to control the gap between the cooling roller 2 and the embossing roller 3 or the pushing depth of the embossing roller 3, i.e. the relative positions of the embossing roller 3 and the cooling roller 4, by, for example, inserting a taper block and one designed to control the force to push the embossing roller 3 by using an air cylinder and the like. However, when a thin film is to be produced by adjusting the thickness of the molten resin 2 at the nip point to 100 μm or less or where the elastomer covering the embossing roller 3 has a rubber hardness of 90 Hs JIS A or more, control by changing the pushing depth may lead to an excessively large pressure unevenness and, therefore, control by changing the pushing force is preferred. An appropriate pushing force may be set as desired, but it is preferably about 0.1 to 5 kN/m. If the pushing force is in the above range, the transfer of the surface pattern from the embossing roller 3 to the molten resin 2 will be performed favorably.

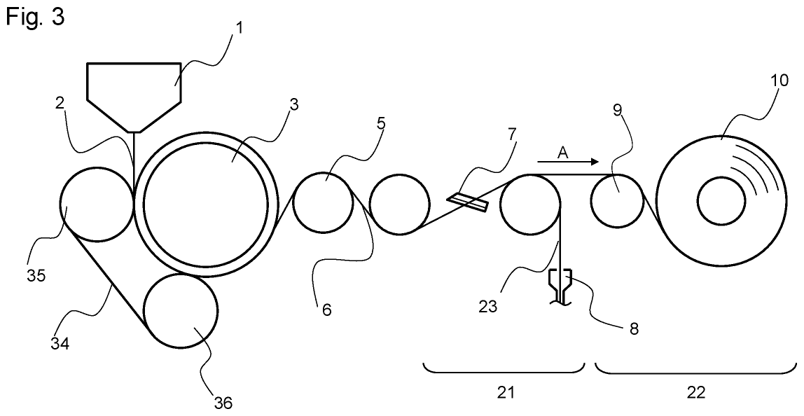

In addition, as illustrated in FIG. 3, a film 6 can also be produced in a similar manner by compressing the molten resin 2 using a cooling belt 34 instead of the cooling roller 4.

The cooling belt 34 is driven by a pressing roller 35 and a cooling conveyance roller 36. The pressing roller 35 may be a rubber roller with its surface covered by rubber, but since the embossing roller 3, which is located opposite to it, is covered by rubber, it is not essential for the pressing roller 35 to be a rubber roller. When the pressing roller 35 has a non-rubber surface, the surface may be treated by a generally known surface treatment method such as industrial chromium plating. It is preferable that the pressing roller 35 and the cooling conveyance roller 36 have structures having a heat transfer medium circulation channel for temperature control to cool the cooling belt 34. Cooling the belt 34 realizes easy release of the molten resin to ensure high speed film production. The pressing roller 35, along with the cooling belt 34 located inside, works in combination with the embossing roller 3 to compress the molten resin 2 in between. The cooling conveyance roller 36 may also be pressed against the embossing roller 3 in a similar manner or may only be located nearby instead of being pressed against it. It is preferable for the cooling conveyance roller 36 to have a crown structure because it prevents the cooling belt 34 from meandering. There may be a plurality of cooling conveyance rollers 36, and in such an example, it is preferable for each of them to have, for example, a temperature control function to control the temperature of the cooling belt 34 or a function to prevent the cooling belt 34 from meandering. Useful means of performing the function to prevent the cooling belt 34 from meandering include the use of the crown structure described above and the use of a so-called edge position controller (EPC) that incorporates an optical sensor or the like to monitor the positional fluctuation of the conveying belt 54 in the width direction and, whenever detecting its meandering, corrects it automatically by adjusting the angle of the cooling conveyance roller 36 from the belt conveyance direction.

If the surface of the cooling belt 34 has a seam, it may be transferred to the surface of the film 6 and, therefore, it is preferable for the cooling belt 34 to be an endless belt free of seams. There are no specific limitations on its material, and it may be of metal such as, for example, stainless steel and nickel.

There are no specific limitations on the thickness of the cooling belt 34, but its thickness is preferably 30 μm to 500 μm. It will be easy to produce a belt having a thickness in this range and also having sufficiently high strength and flexibility.

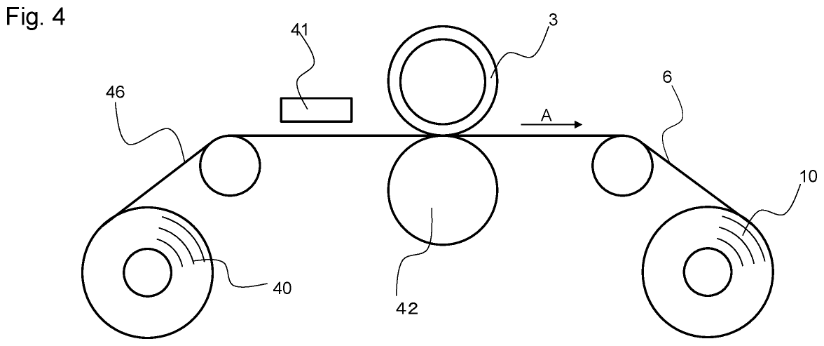

FIG. 4 shows another example of our plastic film production apparatus. This example includes a device that heats a plastic film (hereinafter referred to simply as heating device) 41 to heat the film 46 up to a temperature where at least the surface to be embossed is softened enough so that it can be embossed, and then it is embossed by compressing it between the embossing roller 3 and the receiving roller 42.

The surface temperature of the film 46 before embossing is appropriately set in consideration of the type of resin used and the embossing rate, but in a common polyethylene resin, for example, an appropriate temperature can be normally selected at about 130° C. to 300° C.

There are no specific limitations on the process type used to produce the film 46 to be embossed. Thus, a film produced by the so-called T-die method, in which resin melt-kneaded in an extruder is discharged from a T-die in a web-like form and then cooled and solidified on a cooling roller to provide a film, may be introduced directly, or a film produced by some other film production apparatus and wound up into a film roll 40 may be wound off from a wind-off device and used as illustrated in FIG. 4. Other films produced by common plastic film production methods such as inflation molding may also be used, and the surface of the film 46 opposite to the one to be embossed may be surface-treated by various methods such as plasma treatment, coating, and deposition. In addition, these films may be slit to desired width.

As the heating device 41, those commonly used for film production processes such as, for example, infrared ray heater, hot air supply device, and induction heating roller, can be used. The heating of the film 6 up to a temperature where embossing is possible may be carried out in a single stage or in multiple stages using a plurality of heating devices. As the film 6 is heated up to a temperature where embossing is possible, it may stick to a metal surface or the like and, therefore, a preferred method is to heat it first up to a temperature where sticking does not occur using a contact type heating device such as, for example, induction heating roller and then further heat it up to a temperature where embossing is possible using a non-contact type heating device such as infrared ray heater. Such heating in multiple stages can prevent creasing and deformation of the film 6 during heating.

The embossing roller 3 is the silicone rubber roller 100 for embossing. The use of the silicone rubber roller as the embossing roller 3 can control formation of protrusion defects on that surface of the film 46 that faces the embossing roller 3 as in another example described above.

The receiving roller 42 may be of a material and structure that are generally adopted in film conveying rollers used in common film production apparatuses or processing apparatuses, but it preferably contains a temperature control device such as internal heat transfer medium circulator and heater. The existence of a temperature control device easily maintains the film 46 at a constant temperature and easily prevent irregular embossing.

For the receiving roller 42, an appropriate surface material and shape may be adopted to suite the film to be produced, as in the cooling roller 4. For example, when producing a surface protection film, it is preferable that the surface of the film 46 opposite to the surface coming in contact with the embossing roller 3 is smooth enough to develop required tackiness and, therefore, the surface of the receiving roller 42 preferably has a Ra of 0.2 μm or less, more preferably 0.1 μm or less, as in the cooling roller 4. On the other hand, when producing a film in which both surfaces have crepe patterns, the receiving roller 42 may have a crepe surface and work in combination with the embossing roller 3 to emboss both surfaces simultaneously.

There are various mechanisms that can press the embossing roller 3 against the receiving roller 42 to compress the film 46, but it is preferable to use an air cylinder to perform compression as in pressing it against the cooling roller 4.

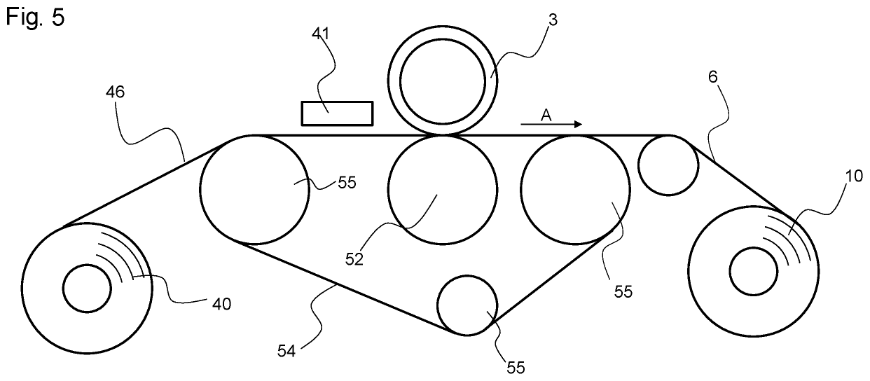

In another example of the plastic film production apparatus, the conveying belt 54 may be used instead of the receiving roller 42 as illustrated in FIG. 5.

It is preferable for the conveying belt 54 to be an endless belt free of seams as in the cooling belt 34. There are no specific limitations on its material, and it may be of metal such as, for example, stainless steel and nickel.

There are no specific limitations on the thickness of the conveying belt 54, but its thickness is preferably 30 μm to 500 μm. It is easy to produce a belt having a thickness in this range and also having sufficiently high strength and flexibility.

When using the conveying belt 54, a heating device 41 may be provided on the conveyance belt to heat the film 46 as illustrated in FIG. 5. If the film 46 is heated to perform embossing, the film 46 will decrease in rigidity and accordingly, in, for example, embossing a film with a thickness of 100 μm or less or a film made only of a low-rigidity resin such as low-density polyethylene, the film tends to be extended or broken in a so-called free span section between rollers. Even in such a film, the above troubles will be avoided if heating is performed on the conveying belt 54 because the film 46 is supported on the conveying belt 54.

The conveying belt 54 is driven by a belt conveying roller 55 and a pressing roller 52. As in the pressing roller 35, the pressing roller 52 may be either a rubber roller or a common surface-treated metal roller. There may be a plurality of belt conveying rollers 52, and it is preferable for each of them to have, for example, a temperature control function to control the temperature of the conveying belt 54 or a function to prevent the conveying belt 54 from meandering. Useful temperature control devices include heat transfer medium circulators in the roller or various heaters. The simplest methods of preventing the conveying belt 54 from meandering include the use of the belt conveying roller 55 in which the outside diameter gradually decreases from the center to the edge in the width direction and the use of a so-called edge position controller (EPC) that incorporates an optical sensor or the like to monitor the positional fluctuation of the conveying belt 54 in the width direction and, whenever detecting its meandering, corrects it automatically by adjusting the angle of the belt conveying roller 55 from the belt conveyance direction.

The surface protection film can be produced by using the silicone rubber roller for embossing and the plastic film production method and production apparatus that use it, and as described above, the silicone rubber roller for embossing forms an embossed surface having low protrusions, which can prevent bruises from being caused on an adherend even when it is a thin optical film such as COP film of 30 μm or less.

The surface protection film may have a single layer structure or a multilayer structure containing two or more layers. In a single layer structure, for example, the apparatus will be so simple that the equipment cost and maintenance cost can be reduced, whereas when using a three layer structure containing an interlayer formed of a recycled material, the material cost can be reduced. Regardless of whether a single layer structure or multi-layered structure is adopted, recycling of materials can be realized easily if the same resin is used in different layers.

At least either of the outermost surfaces of the surface protection film is a crepe surface having fine irregularities. Since either surface of the surface protection film has tackiness, the other surface is treated to have a crepe pattern to prevent creasing and excessive adhesion between two film layers that makes their separation impossible from occurring when winding up it into a roll. However, if a film having a crepe surface with large irregularities is wound up into a roll, the irregularities are transferred to the tacky surface to decrease the tackiness, or if it is wound up into a roll after attaching it to an adherend, irregularities will be transferred to the surface of the adherend in some instances. It is preferable for a crepe surface to have an RzJIS (JIS B 0601: 2013) of 1 to 5 μm and simultaneously have an average length RSm (JIS B 0601: 2013), which is a roughness curvilinear element, of 5 to 40 μm, because this prevents the above problems from occurring easily. Furthermore, it is more preferable for RzJIS and RSm to be 1 to 3 μm and 5 to 15 μm, respectively, because the above problems will not occur easily even in an adherend that is highly liable to the transfer of irregularities such as cycloolefin film with a thickness of 20 μm or less. A stylus type surface roughness measuring instrument is generally used to measure RzJIS and RSm, but in a film that is very dense and fine as described above and simultaneously of a flexible material such as polyethylene resin such a stylus may be so large in needle diameter that not only it is impossible to take accurate measurements, but also a machine-related difference in the needle end shape or contact pressure can lead to different results in some instances. Therefore, it is preferable that measurement of RzJIS and RSm is preferably performed by using a highly accurate, noncontact type measuring instrument such as laser microscope and white light interferometer.

Since the crepe surface of the surface protection film is produced by embossing to transfer the surface pattern of the silicone rubber roller for embossing, each recess in the irregular crepe surface has a substantially hemispherical shape. In addition, since the irregularities are produced by embossing, all protrusions are made of a single material that is the same as that forming the portions containing the recesses.

Compared to this, there are other crepe surface production methods that do not use embossing, including, for example, adding a dissimilar material such as solid particles in the resin that forms the layer in which a crepe pattern is to be produced. In this example, although the addition of spherical particles as dissimilar material can produce an irregular crepe surface containing protrusions that have substantially hemispherical shapes, it is impossible to form recesses having substantially hemispherical shapes and, in addition, the protrusions are made of two or more materials and accordingly, contain a material different from that forming the portions containing the recesses.

There are no specific limitations on the resin to be used as the material of the surface protection film, and useful ones include polyesters such as polyethylene terephthalate and polyethylene-2,6-naphthalate; polyolefins such as polyethylene and polypropylene; polyvinyl such as polyvinyl chloride and polyvinylidene chloride; and others such as polyamide, aromatic polyamide, and polyphenylene sulfide, from which an appropriate one may be selected to suite the required characteristics, but the use of a polyolefin is preferred. In particular, it is particularly preferable to use a low density polyethylene (LDPE) or a linear low density polyethylene (LLDPE) as the material of the layers in which a crepe surface or a tacky surface is to be formed. If a hard resin is used to form irregularities on a crepe surface, when the film is wound up into a roll, the irregularities are transferred to the tacky surface to decrease the tackiness, or if it is wound up into a roll after attaching it to an adherend, irregularities will be transferred to the surface of the adherend in some instances. LDPE and LLDPE are soft enough to avoid such problems. Furthermore, if the surface of a resin to be used has an arithmetic average roughness Ra (JIS B 6010: 2013) of 0.1 μm or less, the surface can develop sufficiently high tackiness for adhesion to a smooth adherend without adding an additive such as sticking agent. This is preferred because it prevents the problem with a sticking agent bleeding out and remaining on the surface of the adherend after peeling off the surface protection film. On the other hand, other resins may be used as the material of other layers than those in which a crepe surface or a tacky surface is to be formed. For example, when LDPE or LLDPE alone cannot form a sufficiently rigid film, high density polyethylene or polypropylene may be used to increase the rigidity. In some instances, a surface protection film that is rigid to some extent may be easier to use because of less possibility of causing problems such as creasing and curling.

### EXAMPLES

Our rollers, methods, apparatus and films will now be illustrated with reference to Examples, but it should be understood that this disclosure is not construed as being limited thereto. The various evaluation methods and measuring methods used are described below. Number of depressions in roller surface

In the surface of a prepared roller, three square portions each having a size of 3 cm×3 cm (referred to as □3 cm) were sampled and observed under a laser microscope. The number of depressions with a maximum size of 30 μm or more was counted for each sample and the numbers of depressions in the three samples were totaled to calculate the number of depressions in the total area of 27 cm².

### Number of Bruises

A retardation film of cycloolefin resin having a smooth surface and a thickness of 40 μm was used as adherend. In Examples 3 to 5 and Comparative Example 2, the surface protection film prepared was stored for 24 hours under the conditions of a temperature of 23° C. and a humidity of 50% RH and bonded to an adherend at a bonding speed of 300 cm/min under a bonding pressure of 9,100 N/m using a roll press machine (special type pressure bonding roller, manufactured by Yasuda Seiki Seisakusho Ltd.). Then, it was sandwiched between smooth polycarbonate plates (with a plate thickness of 2 mm) and stored for 3 days under a load of 1.3 kg/cm² in a hot air oven at 60° C. Subsequently, they were cooled to room temperature and the surface protection film was removed from the adherend. Three square portions each having a size of □3 cm were sampled from the adherend and observed visually to see if there were bruises in the adherend, and the total number of bruises in the three samples was counted.

### Volume Content (Particle Size Distribution) of Solid Particles

Using a laser diffraction and scattering type particle size distribution measuring device (LMS-30, manufactured by Seishin Enterprise Co., Ltd.), the volume-based particle size distribution was measured to determine the cumulative distribution, from which the volume contents of particles having a certain diameter or less or having a certain diameter or more were calculated.

### Example 1

Spherical alumina particles with a volume average particle diameter of 3.5 μm, which were screened in advance to remove those having a particle diameter of 0.8 μm or less and those having a particle diameter of 30 μm or more, were added to an RTV silicone rubber material that was free of solid particles. The particle size distribution of the screened spherical alumina particles was measured and results showed that those having a particle diameter of more than 8 μm and less than 30 μm accounted for 2.5% by volume. The mixture of the RTV silicone rubber material and the spherical alumina particles was stirred and deaerated, and then it was used to coat a roller core having a structure as illustrated in FIG. 1. Subsequently, the surface of the silicone rubber was polished by a rotating grindstone to provide a silicone rubber roller for embossing covered by a silicone rubber layer with a thickness of 10 mm. The resulting silicone rubber layer had a rubber hardness of 80 Hs JIS A (JIS K 6301-1995).

### Example 2

Spherical silicone resin particles with a volume average particle diameter of 3.5 μm, which were screened in advance to remove those having a particle diameter of 0.8 μm or less and those having a particle diameter of 8 μm or more, were added to an RTV silicone rubber material that was free of solid particles. The mixture of the RTV silicone rubber material and the spherical silicone resin particles was stirred and deaerated, and then it was used to coat a roller core having a structure as illustrated in FIG. 1. Subsequently, the surface of the silicone rubber was polished by a rotating grindstone to provide a silicone rubber roller for embossing covered by a silicone rubber layer with a thickness of 10 mm. The resulting silicone rubber layer had a rubber hardness of 81 Hs JIS A (JIS K 6301-1995).

### Comparative Example 1

Spherical alumina particles with a volume average particle diameter of 3 μm and a cut point of 11 μm were added, without being screened, to an RTV silicone rubber material that was free of solid particles. The mixture of the RTV silicone rubber material and the spherical alumina particles was stirred and deaerated, and then it was used to coat a roller core having a structure as illustrated in FIG. 1. Subsequently, the surface of the silicone rubber was polished by a rotating grindstone to provide a silicone rubber roller for embossing covered by a silicone rubber layer with a thickness of 10 mm. The resulting silicone rubber layer had a rubber hardness of 80 Hs JIS A. Before addition, particles with a particle diameter of 0.8 μm or less accounted for 2% to 3% by volume in the whole spherical alumina particles.

Results of production in Examples 1 and 2 and Comparative Example 1 are shown in Tables 1. In Comparative Example 1, although no depression with a size of 300 μm or more was found, there were one depression with a size of 100 μm or more and less than 300 μm and 200 or more depressions with a size of 30 μm or more and less than 100 μm. Compared to this, in Example 1, there were only two depressions with a size of 30 μm or more and less than 100 μm, and no such depressions were found in Example 2. If scratches were seen on the surface, the surface was polished repeatedly until scratches were found no more. In Comparative Example 1, polishing was repeated 15 times until a scratch-free surface was obtained. In Example 1, on the other hand, polishing was repeated only 5 times for finishing. In Example 2, furthermore, the number was 1, which means that re-polishing was not necessary for finishing.

TABLE 1

| | | | | Comparative |
|---|---|---|---|---|
| | | Example 1 | Example 2 | Example 1 |
| Size of roller | | outside diameter 300 mm × | | |
| | | face length 2 m | | |
| Number of | with size of 300 μm or more | 0 | 0 | 0 |
| depressions | with size of 100 μm or more and | 0 | 0 | 1 |
| (number/27 cm²) | less than 300 μm | | | |
| | with size of 30 μm or more and | 2 | 0 | 200 or |
| | less than 100 μm | | | more |

| | | | |
|---|---|---|---|
| Number of repetitions of surface polishing until no | 5 | 1 | 15 |
| scratches are found | | | |

### Example 3

A plastic film production apparatus as illustrated in FIG. 2 was used. From a T-die having a slit with a width adjusted to 0.9 mm, low density polyethylene (LDPE) with a density of 0.93 g/cm³ was discharged at 220° C. into a single layer film, which was then compressed and cooled between a cooling roller and an embossing roller to provide a surface protection film with a thickness of 30 μm. The silicone rubber roller produced in Example 1 was used as the embossing roller.

### Example 4

Except that the silicone rubber roller produced in Example 2 was used as the embossing roller, the same production apparatus and production method as in Example 3 were used to produce a surface protection film.

### Example 5

First, a roll of a single layer film of low density polyethylene (LDPE) with a density of 0.93 g/cm³ was prepared by carrying out the T-die method and winding up the film. Using a plastic film production apparatus as illustrated in FIG. 5, the film was wound off, heated by using an infrared ray heater as heating device to adjust the film surface temperature to 180°, and compressed and cooled between a conveying belt and an embossing roller to provide a surface protection film with a thickness of 30 μm. The silicone rubber roller produced in Example 1 was used as the embossing roller.

### Comparative Example 2

Except that the silicone rubber roller produced in Comparative Example 1 was used as the embossing roller, the same production apparatus and production method as in Example 3 were used to produce a surface protection film.

Using the surface protection films prepared in Examples 3 to 5 and Comparative Example 2, the same procedure as described in the paragraph [Number of bruises] to determine the number of bruises on each adherend. In Comparative Example 2, not less than 200 bruises were found. Compared to this, only one bruise was found in Examples 3 and 5, and no bruise was found in Example 4

### INDUSTRIAL APPLICABILITY

Our concepts can be applied not only to production apparatuses and production methods for surface protection film, but also to production apparatuses and production methods for other plastic film having at least one embossed surface having a crepe pattern, and its scope of application is not limited thereto.

1.-7. (canceled)

8. A rubber roller having a surface covered by a rubber layer containing silicone as primary component, wherein
the rubber layer contains spherical solid particles, and
of the spherical solid particles, those with a particle diameter of 0.8 μm or less and those with a particle diameter of 30 μm or more separately account for 1% or less by volume relative to the total volume of the spherical solid particles.

9. The silicone rubber roller as set forth in claim 8, wherein the spherical solid particles are made of silicone resin.

10. A method of producing a plastic film comprising a step of discharging a molten resin from a die, and a step of compressing the discharged molten resin between an embossing roller and a cooling roller or a cooling belt so that the molten resin is cooled and solidified to provide a web-like plastic film, wherein
the embossing roller is the silicone rubber roller as set forth in claim 8.

11. A method of producing a plastic film comprising a step of heating and softening a plastic film and a subsequent step of compressing and cooling the softened plastic film between an embossing roller and a cooling roller or a cooling belt so that it is solidified to provide a plastic film, wherein
the embossing roller is the silicone rubber roller as set forth in claim 8.

12. A plastic film production apparatus comprising a die, an embossing roller, and either a cooling roller or a cooling belt, wherein
the die, the embossing roller, and the cooling roller or the cooling belt are arranged so that the molten resin is discharged from the die into a web-like form and compressed between the embossing roller and either the cooling roller or the cooling belt, and
the embossing roller is the silicone rubber roller as set forth in claim 8.

13. A plastic film production apparatus comprising a plastic film heating device, an embossing roller, and either a cooling roller or a cooling belt, wherein
the die, the embossing roller, and the cooling roller or the cooling belt are arranged so that the plastic film is heated by the plastic film heating device and compressed between the embossing roller and either the cooling roller or the cooling belt, and
the embossing roller is the silicone rubber roller as set forth in claim 8.

14. A surface protection film comprising a single layer or a plurality of layers, wherein
at least either of the outermost surfaces is a crepe surface having fine irregularities, the recesses in the finely irregular surface have substantially hemispherical shapes, whereas the protrusions are formed of a single material, and
the material constituting the protrusions is identical to the material constituting the portions containing the recesses.
